(19) United States
(12) Patent Application Publication
(10) Pub. No.: US 2002/0041070 A1
(43) Pub. Date: Apr. 11, 2002

(54) Contactless axial carbon seal for a bearing chamber

(76) Inventors: Quac Hung Tran, Liege (BE); Sebastien Rouelle, Bois-Et-Borsu (BE)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/949,009

(22) Filed: Sep. 7, 2001

(30) Foreign Application Priority Data
Sep. 7, 2000 (EP) 00 870 192.2
Sep. 15, 2000 (EP) 00 870 206.0

(51) Int. Cl. F16J 15/34

(52) U.S. Cl. 277/400

(57) ABSTRACT

The present invention relates to a sealing device for a turbomachine bearing, comprising a rotary ring mounted on the portion of the sleeve located on the oil chamber side and a segmented carbon ring which is not in contact with the shaft or with the seal support. The segmented carbon ring bears axially against an annular support by springs. The radial face of the segmented carbon ring engages with the rotary ring via the radial face of the rotary ring by lift slots machined into the rotary ring so as to ensure dynamic sealing during operation, with no friction between the radial faces.

### CROSS-REFERENCE TO RELATED APPLICATIONS

This application claims priority to European Patent Application Number 00 870 192.2, filed Sep. 7, 2000 and to European Patent Application Number 00 870 206.0, filed Sep. 15, 2000, the disclosures of which are herein incorporated by reference in their entireties.

### BACKGROUND OF THE INVENTION

1. Field of the Invention

The present invention relates to a novel sealing device for a turbomachine bearing chamber. This bearing chamber functions equally well at very high and at very low temperatures and can be subjected to inverse pressure.

2. Description of the Related Art

Conventionally, a turbomachine bearing supporting a shaft which rotates inside a fixed pump comprises a rolling bearing arranged in a chamber enabling it to be lubricated. However, any migration of oil to some compartments of the turbomachine must be avoided. A seal is therefore necessary at the separation between the oil-containing bearing chamber and an adjacent air chamber which must be kept oil-free. By inverse pressure, it is understood that, contrary to the usual situation, the pressure within the oil chamber is greater than the pressure within the air chamber.

Various solutions to this problem have been proposed. Therefore, labyrinth seals have been used, which have the advantage of being simple to manufacture and of having a long working life. However, they may give rise to substantial air leakage, which impairs performance, and unbalancing masses about the shaft may cause damage.

This results in an increase in the consumption of oil carried by the air to the air-oil separators and it is possible for oil still to leak from the oil chamber into the air chamber.

Other solutions use carbon seals which can be positioned in various ways. In particular, European document EP A 967,424 illustrates one embodiment already proposed by the Applicant of a contactless axial carbon seal with lift. The carbon ring made in one part engages with a rotating ring comprising a row of lift slots. The device is supplemented with a labyrinth seal in order to avoid any dust penetration in the vicinity of the main seal. This seal cannot work in extreme conditions such as inverse pressure and very high temperature.

U.S. Pat. No. 5,301,957 proposes a radial seal comprising one or two carbon rings in contact with a rotating cylinder cooled by an oil jet. The carbon external or internal surface is provided with slots wherein retention of oil particles takes place (no self-cleaning principle). However there are no lift slots on the rotating part.

U.S. Pat. No. 4,398,730 discloses an axial seal with contact which static ring is maintained by a bellows. The rotating ring cooling is ensured through oil channels bored in this ring. The seal cannot work in the extreme conditions of inverse pressure and very high temperature.

Another proposal of the Applicant, corresponding to the European application EP 055,848, presents a contactless radial ring with lift comprising a static segmented carbon ring blocked axially. The dynamic seal side is cylindrical and the static side is plane. The cylindrical face of the rotating surface comprises lift slots which can however lead to oil particles retention, in spite of the presence of a labyrinth oil reversal system.

European application EP 818,607 proposes a radial segmented carbon seal with contact and cooling of the rotating cylinder. A double protection barrier of the seal against the contaminating fluid is constituted of a annular baffle and a lip seal. The dynamic side of the joint is cylindrical and the static side is plane. The lift slots in the carbon ring lead to oil particles retention.

European document EP 387,122 again illustrates an embodiment of a segmented radial contact seal. Finally, European application EP 562,895 discloses another example.

It is noted that the use of axial or radial contact seals greatly reduces air leakage into the oil chambers and, consequently, the oil consumption after passage through an oil separator.

However, the effects of unbalancing masses about the shaft are not overcome and there is considerable friction causing wear, which limits the working life of these seals. This working life, which is generally shorter than that of labyrinth seals, is often of the order of a few thousand hours and is therefore insufficient for the applications intended for the present invention. Furthermore, these seals give oil leakage at inverse pressures.

### SUMMARY OF THE INVENTION

The present invention aims to provide a novel seal for turbomachine bearing chambers, enabling control of the air leakage from the air chamber into the oil chamber, so as to control the oil consumption by the air-oil separator.

An additional aim of the present invention is to avoid oil leakage from the oil chamber into the air chamber, so as not to pollute the air of the passenger compartment or of the cockpit fed with withdrawals into the compressors.

An additional aim of the present invention is to control the wear and the heating of the seals by friction, so as to achieve the normal working life of the engine and to avoid coking of the oil.

The present invention relates to a sealing device for a turbomachine bearing, said turbomachine comprising an oil chamber and an air chamber. The bearing comprises a rolling bearing mounted between a sleeve securely fixed to a mobile shaft, a bearing support and a seal support. The device separating the oil chamber of the rolling bearing from the air chamber of the turbomachine comprises a rotary ring mounted on the portion of the sleeve located on the oil chamber side and a segmented carbon ring which is not in contact with the shaft or with the seal support.

In the following of the description, the expression “segmented carbon ring” will refer to a ring comprising a plurality of carbon segments or a split ring, made of a single segment.

The segmented carbon ring bears axially against an annular support by means of springs, the radial face of said segmented carbon ring engaging with the rotary ring via the radial face of said rotary ring, by means of lift slots machined into said rotary ring.

This device ensures dynamic sealing of the turbomachine during operation, without friction between the radial faces of the segmented carbon ring and of the rotary ring, respectively.

The bearing chamber equipped with a sealing device according to the invention functions equally well at very high and at very low temperatures and is subjected, where appropriate, to inverse pressure.

According to a preferred embodiment of the invention, the segmented carbon ring comprises means for ensuring semi-static sealing, which are machined directly into the segmented carbon ring, this semi-static sealing also being ensured by compressing the carbon segment(s) on the seal support with the aid of an annular expansion spring.

Advantageously, the segmented carbon ring is maintained contactless with the rotary ring, during operation, in the seal support, by means of the lift slots.

Preferably, the rotary ring is maintained in the axial direction by means of an annular spring, centered on the sleeve with the aid of an elastic seal and driven in rotation by pins.

According to another characteristic of the invention, a device for pumping air by means of a screw and abradable seal, arranged between the seal support and the sleeve, ensures air compression in order to achieve a positive air pressure at the inlet of the segmented carbon seal.

Preferably, the lift slots are arranged on the surface of the rotary ring, such that they ensure dynamic sealing and a rise in air pressure which is sufficient to cancel out the inverse pressure.

In a particularly advantageous manner, the seal is positioned axially by means of an adjusting wedge and is provided with an anti-rotation blocking device, the blocking device also ensuring axial blocking of the segmented carbon ring in the free state.

### BRIEF DESCRIPTION OF THE DRAWINGS

FIG. 1 represents, in a cross section view, a plane passing through the rotational axis of the shaft, a portion of turbomachine bearing comprising a chamber sealing device according to the present invention.

FIG. 2 is a view in enlarged detail of the segmented carbon ring.

FIG. 3 is a detailed view of the rotary ring, showing an example of sealing lift slots.

### DETAILED DESCRIPTION OF THE PREFERRED EMBODIMENT

The contactless axial carbon seals for inverse pressures and for very high or very low temperatures, according to the invention, are technical improvements of conventional axial contact or contactless carbon seals.

They provide the following advantages: very little air leakage from the air chamber into the oil chamber; very little consumption of oil through the oil separators; no oil leakage from the oil chamber into the air chamber, even for an inverse pressure; use at very high and very low temperature; no friction or wear, and thus a very long working life; and, insensitivity to the nominal unbalancing masses about the shaft.

The design of the contactless axial carbon seals under these conditions requires that particular attention be paid to the pressure balance around the carbon ring, without secondary seals and without deformation of the rotary ring.

The leakage clearance is large enough to ensure that there is no contact of the seal and small enough to ensure the intended air leakage and no oil leakage.

The shape and direction of the slots on the rotary ring must create a film of air which separates the carbon ring from the rotary ring.

An additional pressurization system before the air inlet of the seal allows the inverse pressure to be counterbalanced.

Other characteristics and advantages of the invention will be understood more clearly on reading the description which follows of one embodiment of the invention, with reference to the attached drawings.

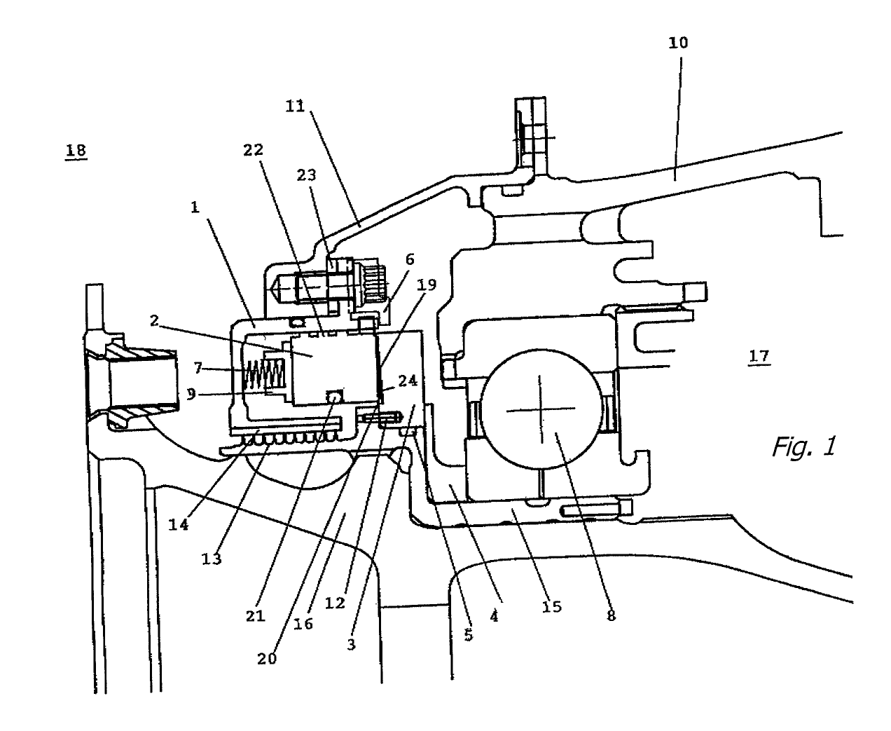

According to the representation given by FIG. 1, a shaft 16 is rotationally supported by a bearing carried by a sump or bearing support 10 and comprising a rolling bearing 8. The rolling bearing 8 is inside a so-called “oil chamber” 17, in which are present both air and oil on account of the lubrication of said rolling bearing which is provided in a manner which is known per se and which has not been shown in FIG. 1. Beyond the support bearing, the shaft 16 is surrounded by a so-called “air chamber” 18. This chamber must be kept oil-free at the point of the air withdrawals that are carried out in a manner which is known per se, requiring the use of clean air, so as not to increase the pressurization and filtration problems.

The preferred embodiment of the invention proposed below avoids the various drawbacks of the prior art, while at the same time providing the desired sealing between the air chamber 18 and the oil chamber 17, even in the case of an inverse pressure and a very high or very low temperature.

The sealing device which satisfies these conditions is characterized in that it comprises an envelope 1 on the static part of the seal, a segmented carbon ring 2, and a rotary ring 3 made of carbide or coated with carbide, generating a lift effect on the contact surface 19, via slots 24, preferably located along a plurality of rows and which depth is variable, engaging with the surface 20 of the segmented carbon ring 2.

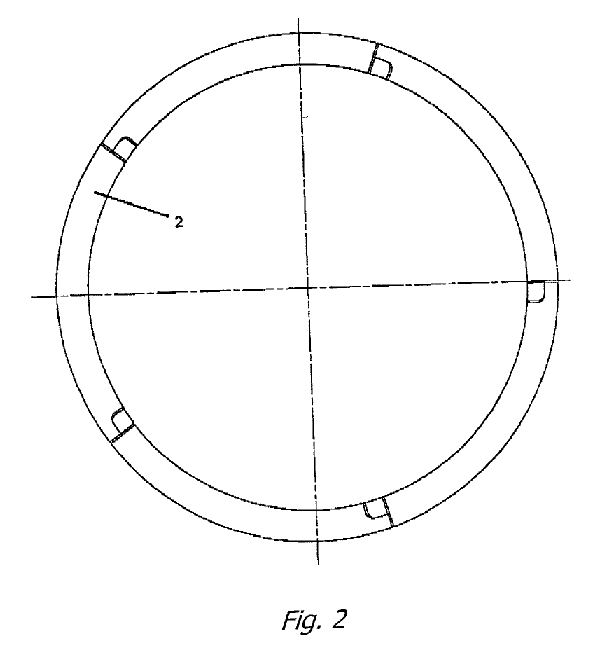

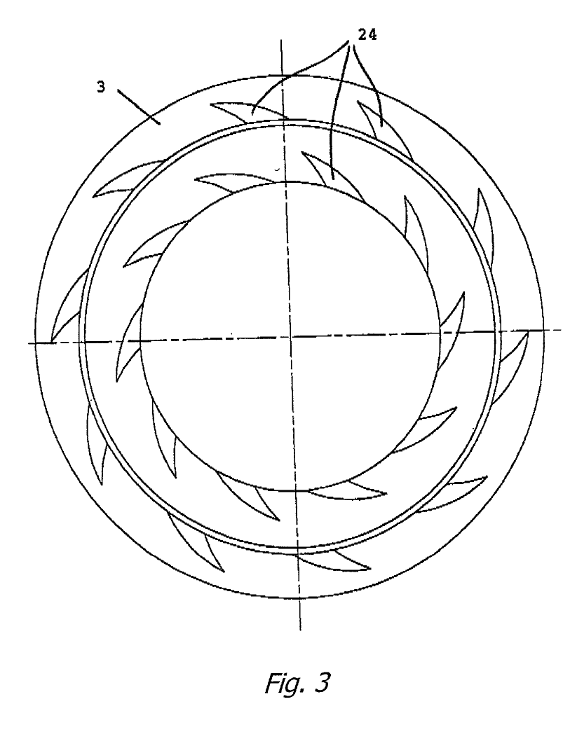

The embodiment details of the segmented carbon ring 2 and of the rotary ring 3 are shown in FIGS. 2 and 3, respectively.

The rotary ring is centered on, but not fixed to, a sleeve 15, which is itself fixed to the shaft 16, by means of an elastic seal 5 which takes up the clearance and withstands the operation temperatures. The assembly faces the rolling bearing 8, which is itself mounted on the support 10.

The rotary ring 3 is driven by anti-rotation blocking pins 12 and is maintained only in axial displacement by a spring 4, for example an annular spring.

An axial anti-rotation blocking system 6 allows the carbon ring 2 to remain in its support 1, in the free state and during operation.

An axial load for maintaining contact between the segmented carbon ring 2 and the rotary ring 3, in the free state, is achieved by means of axial springs 7, maintained by a retaining ring 9.

A secondary semi-static seal 22, machined directly into the segmented carbon ring 2, has limit operation temperatures in the region of those of the segmented carbon ring 2. This static sealing is provided by an annular expansion spring 21 which achieves the contact between the segmented carbon ring 2 and the seal support 1.

A system for pumping air by means of a screw 13 and abradable seal 14 allows the air pressure inside the air chamber 18, at the carbon seal inlet, to be returned to a value greater than that in the oil chamber 17, so as to ensure that there are no oil leakage in any of the flight configurations.

The air chamber 18 thus provides the air-side pressurization of the segmented carbon ring 2 and the oil chamber 17 provides the oil-side pressure of the bearing chamber.

A support 11 combines the fixing of the envelope 1 with the axial position adjustment by means of a wedge 23 and separates the air chamber 18 from the oil chamber 17.

A particularly advantageous embodiment of the invention results from the combination of a carbon ring 2 made of a plurality of segments or of a split ring (contrary to EP Application 967,424, U.S. Pat. No. 5,301,957, U.S. Pat. No. 4,398,730), of a rotating ring 3 comprising at least one row of lift slots, an air pumping device 13,14 (contrary to EP Application 967,424, U.S. Pat. No. 4,398,730) and a circular (radial) expansion spring 21 of the carbon ring (contrary to EP-A-0 967 424, U.S. Pat. No. 5,301,957, U.S. Pat. No. 4,398,730, EP Application 055,848, EP Application 818,607) for the achievement of a semi-static sealing 22.

It is noteworthy that generally the springs associated to carbon rings mentioned in prior art are circumferential rings of support of said segments in one part and not expansion rings.

These arrangements, which are noteworthy according to the invention, allow the desired aims to be achieved. In particular, the air leakage from the air chamber into the oil chamber is greatly reduced, thus making it possible to control the oil consumption and to avoid any impairment of the performance qualities. Oil leakage from the oil chamber into the air chamber, under the condition of inverse pressure, is also avoided, thereby preventing the air used in the aircraft ancillaries from becoming polluted. By eliminating friction, heating of the seal is avoided, as are the damage and/or wear resulting therefrom. The working lives of seals are therefore significantly extended. In addition, the device works at the very high and very low temperatures, respectively, prevailing in turbomachines.

What is claimed is:

1. A sealing device for a turbomachine bearing, said turbomachine comprising an oil chamber and an air chamber, said turbomachine bearing comprising a rolling bearing mounted between a sleeve securely fixed to a mobile shaft, a bearing support and a seal support, said sealing device separating the oil chamber of the rolling bearing from the air chamber of the turbomachine, said sealing device comprising:
an annular support;
a rotary ring mounted on the portion of the sleeve located on the oil chamber side, said rotary ring having an axial face; and
a segmented carbon ring which is not in contact with the shaft or with the seal support, said segmented carbon ring bearing axially against said annular support by springs, said segmented carbon ring having an axial face;
wherein the radial face of said segmented carbon ring engages with the radial face of said rotary ring by lift slots machined onto said rotary ring so as to ensure dynamic sealing during operation.

2. The sealing device of claim 1, wherein there is no friction between the radial faces of said rotary ring and said segmented carbon ring.

3. The sealing device of claim 1, wherein the segmented carbon ring comprises a semi-static sealing member machined directly onto the segmented carbon ring.

4. The sealing device of claim 3, further comprising an annular expansion spring which compresses at least one carbon segment to ensure the semi-static sealing.

5. The sealing device of claim 1, wherein said lifts slots are arranged in a plurality of rows.

6. The sealing device of claim 1, wherein said segmented carbon ring is maintained contactless with the rotary ring in the support by the lift slots.

7. The sealing device of claim 1, wherein said rotary ring is maintained in the axial direction by an annular spring centered on the sleeve with the aid of an elastic seal and driven in rotation by pins.

8. The sealing device of claim 1, further comprising a device for pumping air comprising a screw and abradable seal positioned between the support and the sleeve said device ensuring air compression in order to achieve a positive air pressure at the inlet of the segmented carbon ring.

9. The sealing device of claim 1, wherein said lift slots are arranged on the surface of the rotary ring to ensure dynamic sealing and a rise in air pressure which is sufficient to cancel out the inverse pressure.

10. The sealing device of claim 1, wherein the seal is positioned axially by an adjusting wedge.

11. The sealing device of claim 1, wherein the seal is provided with an anti-rotation blocking device said blocking device ensuring axial blocking of the segmented carbon ring in the free state.
